(19) United States
(12) Patent Application Publication
(10) Pub. No.: US 2015/0075880 A1
(43) Pub. Date: Mar. 19, 2015

(54) ELECTRIC CART FOR FACILITATING THE HARVESTING OF BERRIES AND OTHER CROPS

(71) Applicant: GK Machine, Inc., Donald, OR (US)

(72) Inventors: Gary Grossen, Gervais, OR (US); Scott Grossen, Silverton, OR (US); Nathan Keeley, Woodburn, OR (US)

(73) Assignee: GK Machine, Inc., Donald, OR (US)

(21) Appl. No.: 14/026,939

(22) Filed: Sep. 13, 2013

(51) Int. Cl. B60P 3/00

(52) U.S. Cl. CPC B60P 3/00
USPC 180/2.2; 180/65.1; 180/19.2

(57) ABSTRACT

An electric cart for facilitating the harvesting of berries and other crops comprising a steering side wheel assembly with a front steering wheel and a rear drive wheel connected by a first connecting member and a caster side wheel assembly comprising a front caster wheel and a rear drive wheel connected by a second connecting member. Both drive wheels are connected to battery-powered motors. A main cross-bar connects the castor side wheel assembly to the steering side wheel assembly and maintains an adjustable distance between the first and second connecting members. The invention preferably includes a plurality of solar panels that charge the batteries that supply power to the first and second battery-powered motors.

### BACKGROUND OF THE INVENTION

1. Field of the Invention

The present invention relates generally to the field of electric vehicles, and more specifically, to an electric cart that is designed to facilitate the harvesting of berries and other crops.

2. Description of the Related Art

Current harvest machines tend to be large and powered by a combustion engine. These machines need to operate in close proximity to the operator (for convenience reasons) and often within a greenhouse structure. The exhaust and noise are a constant irritation to the operators. Furthermore, the combustion engines require support fluids, such as engine oil, fuel, and usually hydraulic oil. All of these fluids can ruin product viability if they come into contact with the crops. Combustion engines also require refueling and handling of flammable liquids often near ignition sources; as such, they require a constant vigilance in fire hazard safety. In the case of transient labor, there is often little time or opportunity for such training. Serviceability is rarely considered with conventional harvest machines, and maintenance is increased due to the use of combustion engines. All of these factors negatively impact productivity.

In order to be economically viable, conventional (combustion engine) harvest machines are often scaled so that they can be used by several picker/operators at a time. This requires greater skill levels (in terms of safety, maintenance, etc.) across an entire operating crew. Furthermore, the large size of most harvest machines leads to complications in handling or transporting the equipment, and it also increases the risk that the machine may cause serious injuries. In addition, the larger scale of the machine often causes a more significant impact on the soil structure, reducing crop health. Small component failure can often disable an entire machine until replacements are fitted. Breakdowns or adjustments usually stop large crews from working, which in turn reduces overall productivity. For the reasons explained below, all of these limitations are overcome by the present invention.

There are no existing inventions that embody the advantages of the present invention. For example, U.S. Patent Application Pub. No. 2012/0186213 (Orlando et al.) discloses an electrically powered agricultural funicular traction system consisting of two automatically driven, electrically powered machines connected by a cable. U.S. Patent Application Pub. Nos. 2013/0022430 and 2013/0019580 (Anderson et al.) provides a bidirectional harvesting vehicle comprised of a base unit and a material gathering device that is attached to either a first end or a second end of the vehicle, depending upon the direction in which the vehicle is traveling. Neither of these inventions possesses is structurally or functionally similar to the present invention.

### BRIEF SUMMARY OF THE INVENTION

The present invention is an electric cart for facilitating the harvesting of berries and other crops comprising: a steering side wheel assembly comprising a front wheel and a rear wheel connected by a first connecting member, wherein the front wheel is a steering wheel, and the rear wheel is a drive wheel connected to a first battery-powered motor; a caster side wheel assembly comprising a front wheel and a rear wheel connected by a second connecting member, wherein the front wheel is a caster wheel, and the rear wheel is a drive wheel connected to a second battery-powered motor; and a main cross-bar connecting the caster side wheel assembly to the steering side wheel assembly so that there is a certain distance between the first and second connecting members, wherein the certain distance between the first and second connecting members is adjustable. In a preferred embodiment, the invention further comprises a plurality of solar panels that charge at least one battery that supplies power to the first and second battery-powered motors.

In a preferred embodiment, a first pair of tubular extensions extends laterally from the first connecting member, and a second pair of tubular extensions extends laterally from the second connecting member; the main cross-bar comprises a first end and a second end, and the first end of the main cross-bar is inserted into the first pair of tubular extensions, and the second end of the main cross-bar is inserted into the second pair of tubular extension; and the main cross-bar rotates within the first and second pairs of tubular extensions to allow the electric cart to accommodate variations in the terrain. Preferably, the electric cart is fully collapsible for transport or storage. Each of the drive wheels preferably comprises a disengageable drive hub.

In one embodiment, the invention further comprises a first set of racks for storing empty trays and a second set of racks for storing full trays; the first set of racks is positioned on top of the steering side wheel assembly; and the second set of racks is positioned directly underneath the first set of racks. In another embodiment, the invention further comprising a first set of racks for storing empty trays and a second set of racks for storing full trays; the first set of racks is positioned on top of the caster side wheel assembly: and the second set of racks is positioned directly underneath the first set of racks.

In a preferred embodiment, the electric cart has a manual mode and an auto mode; and the electric cart travels at a pre-determined speed for a given time interval when the auto mode is activated. Preferably, the given time interval is adjustable by the operator. The electric cart preferably automatically reverts to manual mode after the given time interval expires.

In a preferred embodiment, the invention further comprises a guide handle that is pivotally attached to a bracket in proximity to an outer end of an axle of the steering wheel, and the guide handle is configured to be held in a first position when the electric cart is in manual mode and a second position when the electric cart is in auto mode. Preferably, the invention further comprises at least one emergency stop that terminates all power to the electric cart when activated. The invention preferably further comprises a forward/reverse switch that controls a direction of travel of the electric cart.

In a preferred embodiment, the invention further comprises a steering sensor; the steering side wheel assembly further comprises a steering fork assembly; and the steering sensor senses the position of the steering fork assembly and varies power to the first battery-powered motor to facilitate a turn. Preferably, the invention further comprises a steering sensor; the steering side wheel assembly further comprises a steering fork assembly; and the steering sensor senses the position of the steering fork assembly and varies power to the second battery-powered motor to facilitate a turn. The steering side wheel assembly preferably further comprises a steering fork assembly; the steering fork assembly comprises a steering fork; and the electric cart further comprises one or more stops that prevent over-rotation of the steering fork.

### BRIEF DESCRIPTION OF THE DRAWINGS

FIG. 1 is a perspective view of the present invention shown fully assembled.

FIG. 2 is a perspective view of the present invention showing how the empty and full trays are stored on the machine.

FIG. 3 is a detail perspective view of the storage racks for the empty trays.

FIG. 4A is a perspective view of the empty tray storage assembly of the present invention shown with the storage racks in a first position.

FIG. 4B is a perspective view of the empty tray storage assembly of the present invention shown with the storage racks in a second position.

FIG. 5A is a perspective view of the present invention shown without any empty or full trays and with the solar panels tilted for transport.

FIG. 5B is a detail view of the solar panel tilt mechanism.

FIG. 6 is a detail perspective view of the emergency stop.

FIG. 7 is a partial exploded view of the caster side of the present invention.

FIG. 8 is a detail perspective view of the rear control box.

FIG. 9A is a detail perspective view of the guide handle shown in an up position.

FIG. 9B is a detail perspective view of the guide handle shown in a down position.

FIG. 9C is a detail side view of the release handle.

FIG. 10 is a rear view of the caster side wheel assembly and the steering side wheel assembly shown in a first relative position on the width adjustment tube.

FIG. 11 is a rear view of the caster side wheel assembly and the steering side wheel assembly shown in a second relative position on the width adjustment tube.

FIG. 12 is a rear view of the caster side wheel assembly and the steering side wheel assembly shown in a third relative position on the width adjustment tube.

FIG. 13 is an exploded view of the caster side wheel assembly, the steering side wheel assembly, and the width adjustment tube.

FIG. 14A is an exploded view of the battery compartment.

FIG. 14B is an exploded view of the battery compartment.

FIG. 15 is a detail perspective view of the main control box.

FIG. 16 is a partial exploded view of the main control box and batteries showing the internal harness.

FIG. 17 is a detail perspective view of the locking hub assembly shown with the hubs engaged.

FIG. 18 is a detail perspective view of the locking hub assembly shown with the hubs disengaged.

FIG. 19 is an exploded view of the locking hub assembly.

FIG. 20 is a front perspective view of the drive hub key.

FIG. 21 is a rear perspective view of the drive hub key.

FIG. 22 is an exploded view of the caster side base assembly.

FIG. 23 is an exploded perspective view of the motor and drive assembly.

FIG. 24 is an exploded view of the front wheel assembly on the steering side.

FIG. 25 is a top view of the front wheel assembly on the steering side.

FIG. 26 is a perspective view of the invention in a fully collapsed and partially disassembled state ready for shipment.

### REFERENCE NUMBERS

1 Bed (of berries)
2 Empty tray
3 Full tray
4 Solar panel
5 First set of racks (for empty trays)
5a First half (of rack 5)
5b Second half (of rack 5)
6 Second set of racks (for full trays)
7 Rubber strap
8 Aperture (in vertical surface of rack 5)
9 Cross-member
10 Vertical post
11 Emergency stop
12 Button (on emergency stop)
13 Strain relief
14 Support member
15 Bracket
16 Tubular extension
17 Connecting member
18 Rear control box
19 Auto mode button
20 Time adjustment knob
21 Guide handle
22 Bracket
23 Release handle
24 Bolt
25 Twist throttle
26 Mud scraper
27 Rear wheel
28 Gear box
29a Inner drive tube
29b Outer drive tube
30 Cylindrical cover
31 Motor
32 Battery compartment
32a Battery compartment cover
33 Main cross-bar
34 Pin
35 Aperture (in main cross-bar)
36 Main control box
37 Battery
38 Hinged cover (on battery compartment)
39 Auto power knob
40 Forward/reverse switch
41 Internal harness
42 First receptacle
43 Second receptacle
44 Third receptacle
45 Fourth receptacle
46 Shaft
47 Keyway
48 Washer
49 Collar
50 Wheel hub
51 Snap ring
52 Drive hub key
53 Nut
54 Spring
55 Washer
56 Bolt
57 Hub cap
58 Internal key (on drive hub key)
59 Grip tab (on drive hub key)
60 Angle bracket
61 Channel bracket
62 Steering fork
63 Hub cover
64 Stop
65 Steering sensor
66 Hub cap
67 Slot (in release handle)
68 Roof brace
69 Locking bar
70 Lock
71 Locking bracket
72 Locking bar slot
73 Solar panel support channel
74 Spacer

### DETAILED DESCRIPTION OF INVENTION

The present invention is a battery-operated cart for facilitating the harvesting of berries and other crops. The invention is smaller and lighter than conventional harvest assist machines, and it is preferably solar-charged. The four-wheel articulated frame of the present invention is more stable than prior art designs, and the frame is also adjustable.

A first advantage of the present invention is that it replaces the gas engine with an electric power train. As such, the need for liquid fuel and hydraulic oil is eliminated, thereby reducing the chance of crop contamination. Without a gasoline engine, the 100-hour service interval (typically applicable to conventional harvesting machines) no lunger applies, and the service life of the equipment is extended into the thousands of hours. Furthermore, with optional solar recharging, there is no need for daily recharging of the battery via an electric power source.

A second advantage of the present invention is that it is sized appropriately for single- or double-user crews. The invention is also designed so that the width of the machine can be adjusted easily by one or two people. The smaller overall size of the invention means that it has a smaller, lighter footprint than conventional machines. This in turn reduces ground compaction and provides a safer work environment. The smaller size of the machine also means that it can be more easily transported.

A third advantage of the present invention is that it can be collapsed down significantly or even disassembled to provide extremely tight packaging of multiple machines without requiring tools or long set-up or take-down times.

A fourth advantage of the present invention is that the drive hub can be disengaged to allow towing of the machine at slow speeds for short distances. The latter capability is beneficial in the event the machine malfunctions or needs to be moved down field roads at a speed greater than the operating speed of the machine. Because of this towing capacity, more than one machine can be ganged together to allow one machine to tow several others to the operating area from a place of storage.

A fifth advantage of the present invention is that it greatly improves serviceability and decreases required maintenance. With an electric drive motor, there are very few wear items on the machines. The electric motors have extremely long service intervals, and the drive gear boxes need only infrequent oil changes (biodegradable oils may be used to eliminate contamination risk). The electrical control system is plug-in, there are no end user serviceable parts, and the package is delivered as a module that can be rapidly swapped for a functioning unit with no tuning or individualization needed. Without solar power, there is a significant reduction in fuel costs. With solar power, fuel costs are effectively eliminated.

A sixth advantage of the present invention is that it incorporates a four-wheel configuration, with one furrow-guided (steering) wheel and one trailing swivel (caster) wheel in the front and two driving wheels in the rear. The machine can be easily reconfigured to provide two swivel wheels in the front and a separate operator-guided steering control at the rear, if needed, depending upon the type of crop and field application.

A seventh advantage of the present invention is that it is equipped to carry empty picking containers into a field and to store these containers in another location on the machine once they are full of berries. This saves the operator the effort of carrying each full container out of the field or carrying empty containers with him while harvesting.

An eighth advantage of the present invention is that it is configured to stay just ahead of the harvester/operator with minimal interaction between the user and the machine. At the end of the picking rows, the machine is easily guided into the next harvest area by the operator and then travels through the harvest area either self-guided or guided manually. To allow the machine to recharge its batteries, the machine is configured to move forward a preset distance at the touch of a button and then wait (while recharging) for another signal from the operator. This allows the machine to stay out of the way of the operator with little interaction or guidance. These and other advantages are discussed more fully below with reference to the figures.

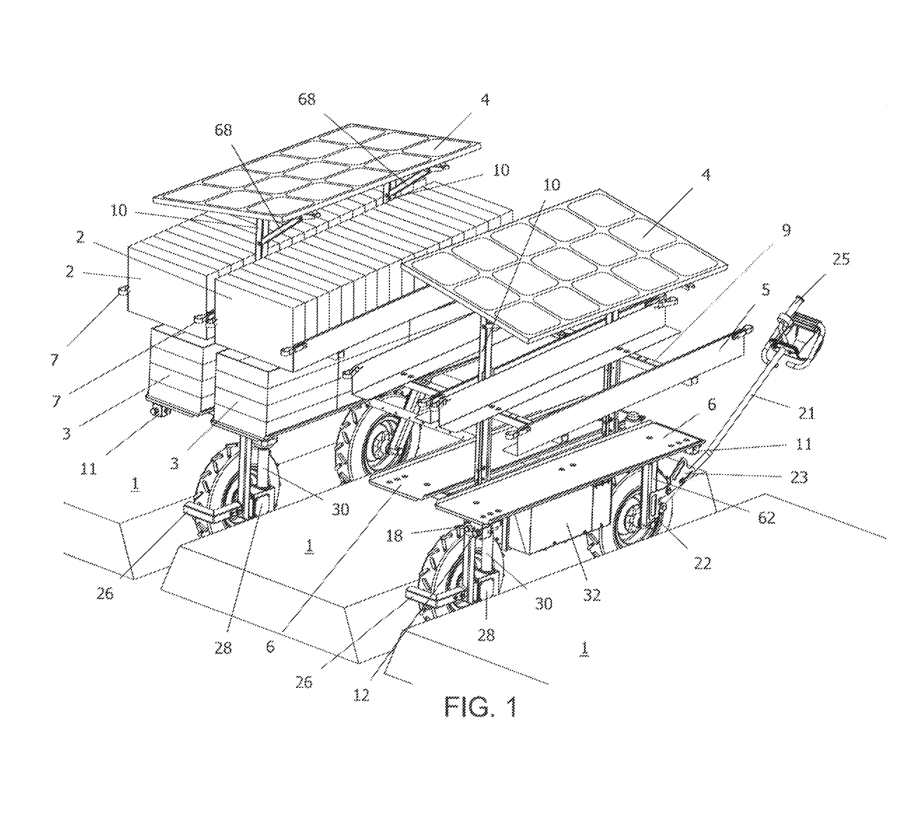

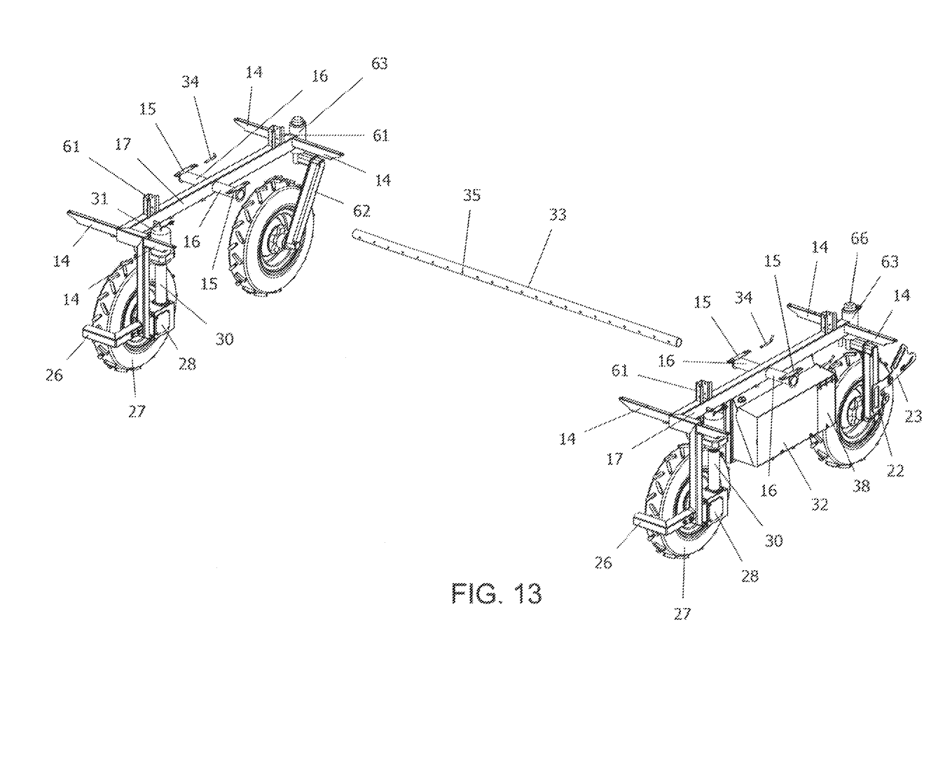

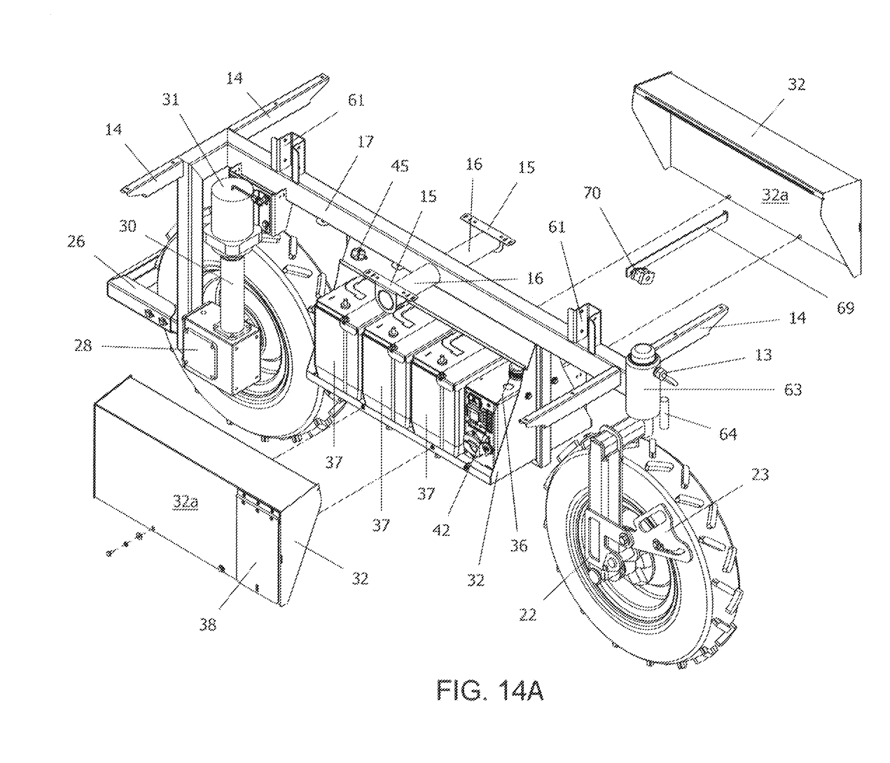

FIG. 1 is a perspective view of the present invention shown fully assembled. As shown in this figure, the invention comprises two pairs of front and rear wheels—one on the steering side (the two wheels on the lower right-hand side of the figure) and one on the caster side (the two wheels on the upper left-hand side of the figure). The two steering side wheels are aligned so that the rear wheel is directly behind the front wheel on the steering side, and the rear wheel is directly behind the pivot axis of the front wheel on the casting side. The invention is configured so that the two steering side wheels and the two caster side fall on either side of a bed of berries 1. As explained below (particularly in connection with FIG. 13), the width of the invention—that is, the distance between the steering side wheels and the caster side wheels—is adjustable.

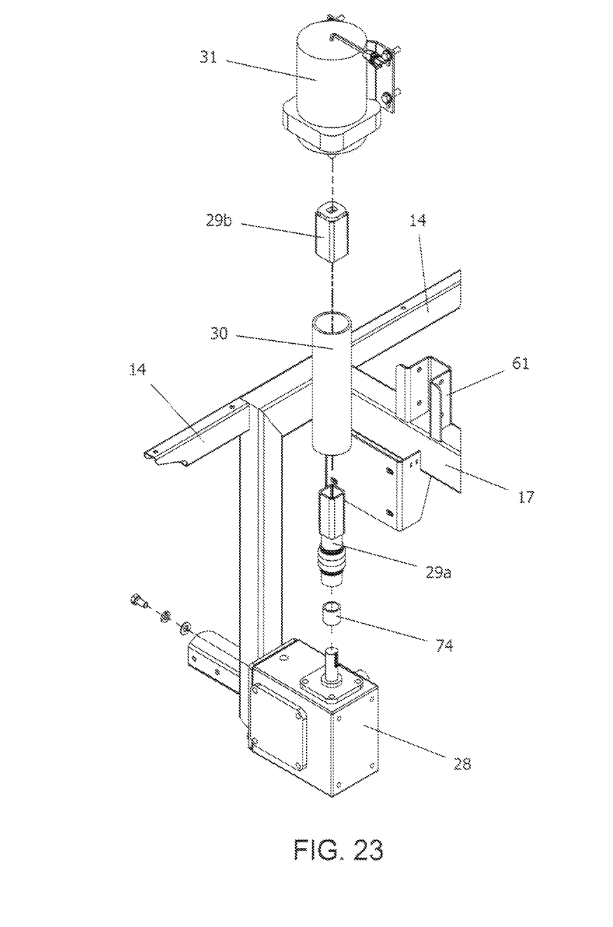

FIG. 1 also shows that the invention is configured to hold both empty 2 and full 3 berry trays. In the embodiment shown in this figure, the invention comprises tiltable solar panels 4 that recharge the batteries that provide power to the two drive motors (see FIG. 23).

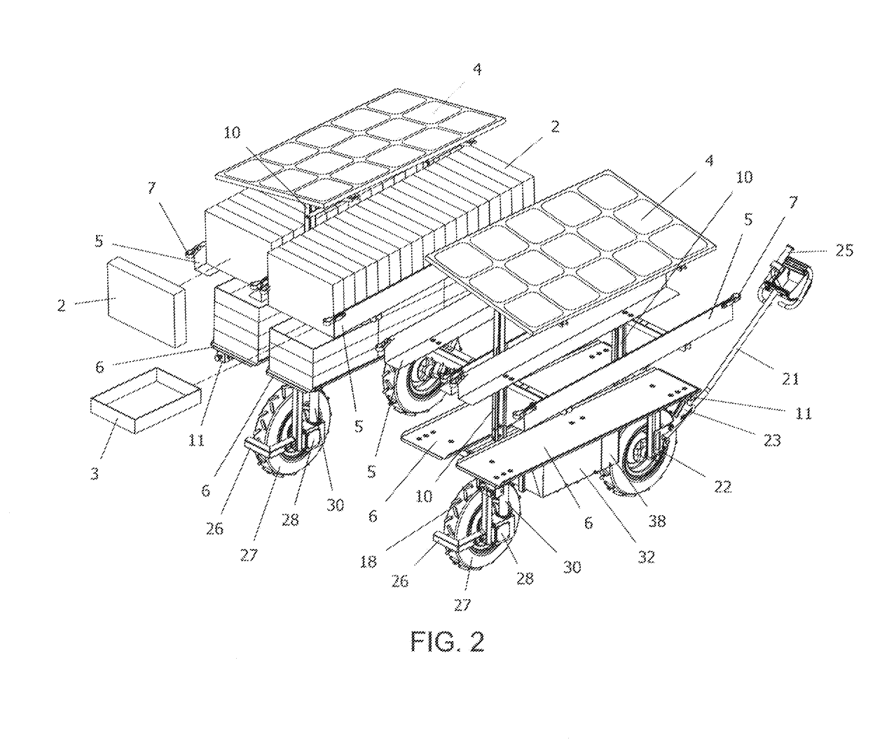

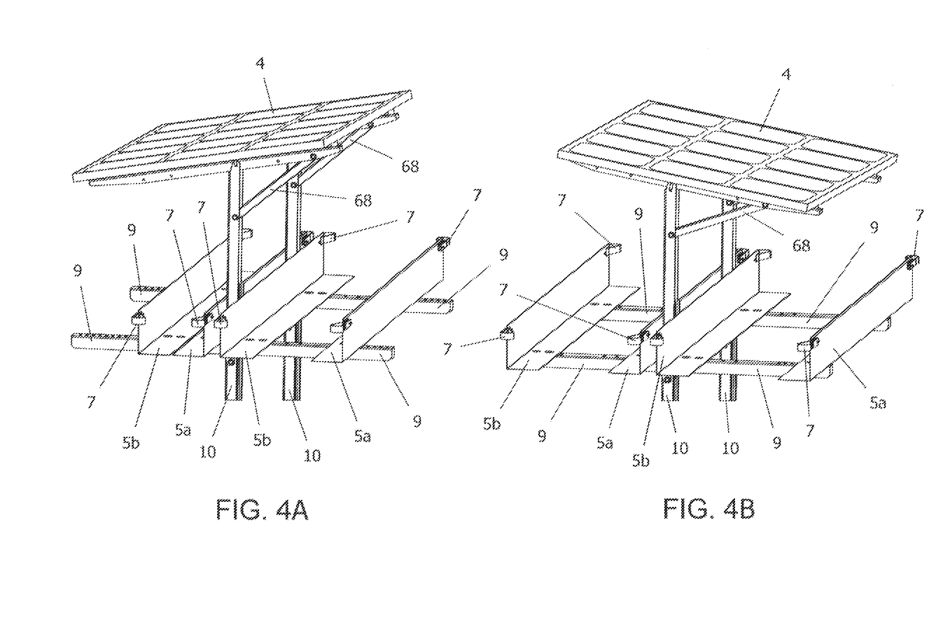

FIG. 2 is a perspective view of the present invention showing how the empty and full trays are stored on the machine. As shown in this figure, the empty trays 2 are stacked horizontally on top of a first set of racks 5 that are adjustable (see FIGS. 4A and 4B). The full trays 3 are stacked vertically on top of a second set of racks 6 that are positioned directly underneath the first set of racks 5.

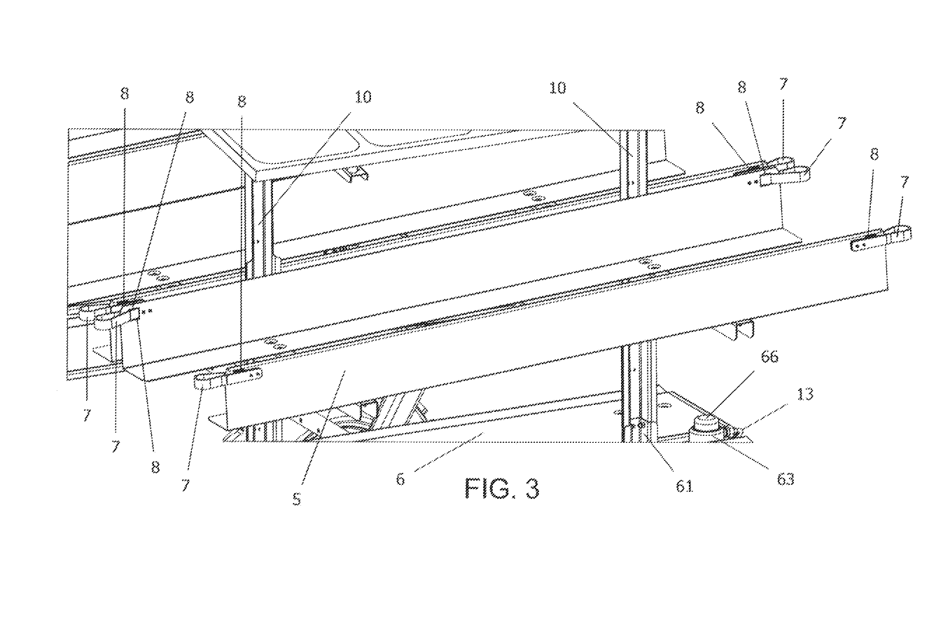

FIG. 3 is a detail perspective view of the storage racks for the empty trays. In a preferred embodiment, each end of each rack in the first set of racks 5 comprises a rubber strap 7. In this particular embodiment, one end of the rubber strap 7 is inserted into an aperture 8 on the inside surface of one end of the rack 5. The rubber strap 7 is then looped around and secured to the outside surface of the same end of the rack 5. The purpose of these rubber straps 7 is to prevent the stacked empty trays 2 (not shown) from falling off of the racks 5. The rubber straps 7 work well because they provide enough friction to keep the empty trays 2 on the racks 5 while still allowing them to be easily removed from the racks 5. The present invention is not limited to any particular method keeping the empty trays 2 on the racks 5.

FIG. 4A is a perspective view of the empty tray storage assembly of the present invention shown with the storage racks in a first position, and FIG. 4B is a perspective view of the empty tray storage assembly of the present invention shown with the storage racks in a second position. As shown in these two figures, the width of the first set of racks 5 is adjustable. Each rack 5 comprises a first half 5a and a second half 5b. The first and second halves 5a, 5b each comprises two planar surfaces, one horizontal and one vertical, joined together at a ninety (90)-degree angle. The rubber straps 7 discussed above are preferably situated on the ends of the vertical surfaces. The horizontal surface of each rack is bolted to two cross-members 9, which in turn are secured to vertical post 10. The horizontal surface of the rack is preferably secured to the cross-members 9 with bolts. The cross-members 9 comprise a plurality of bolt holes, which allow the width of each rack to be adjusted.

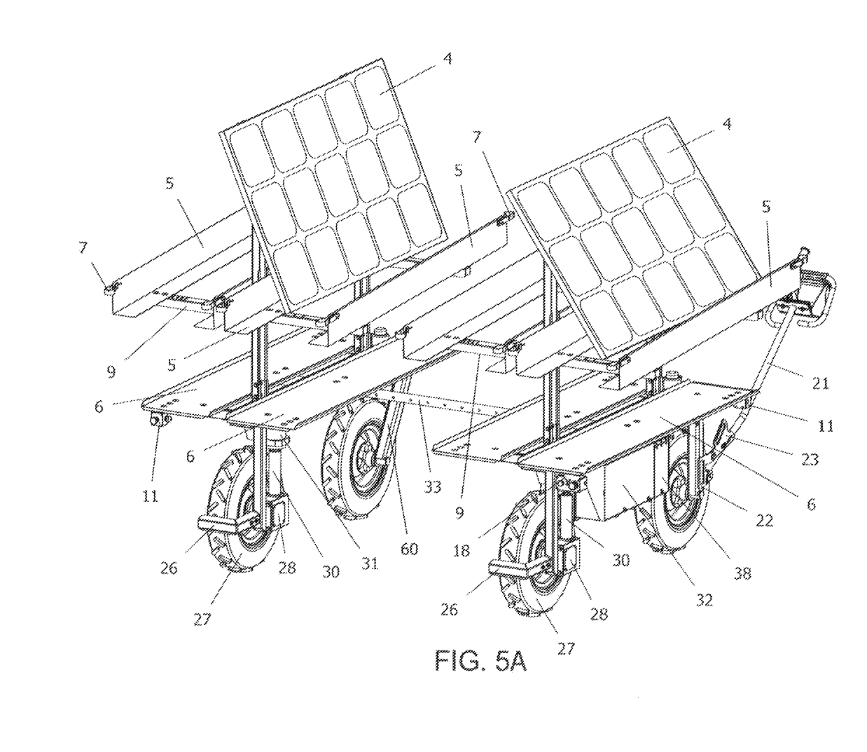

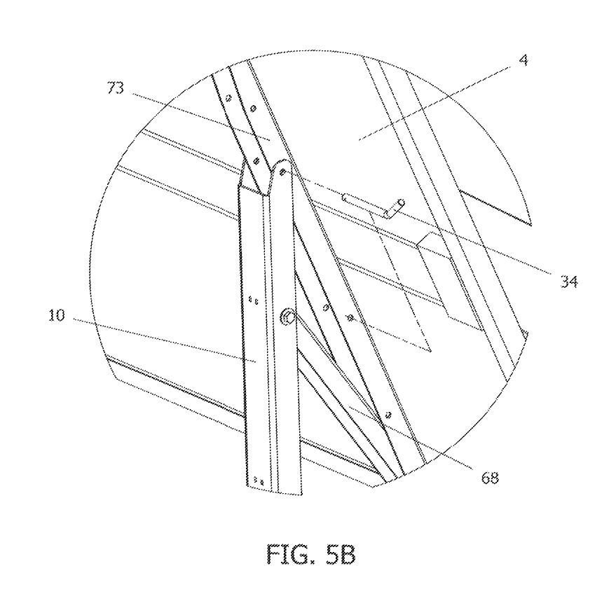

FIG. 5A is a perspective view of the present invention shown without any empty or full trays and with the solar panels tilted for transport. As noted above, the solar panels 4 are preferably tiltable. Tilting of the solar panels 4 to a more vertical orientation than that shown in FIG. 1 may be desired for transporting the invention from field to field. Tilting of the solar panels in this manner reduces the possibility of damage to the solar panels 4 during transit, and it also reduces the air pressure underneath the solar panels that attempts to lift them upward when they are in a relatively horizontal position and moving at an appreciable speed.

FIG. 5B is a detail view of the solar panel tilt mechanism. This figure shows how the angle of the solar panels 4 is adjusted. As shown in this figure, the vertical post 10 is pivotaliy attached to a roof brace 68. The top end of the vertical post 10 is secured (in this case with a pin 34) to a solar panel support channel 73 located directly underneath the solar panel 4. To adjust the position of the solar panel 4, the pin 34 is removed, the top end of the vertical post 10 is moved to a different set of holes in the solar panel support channel 73, and the pin 34 is reinserted.

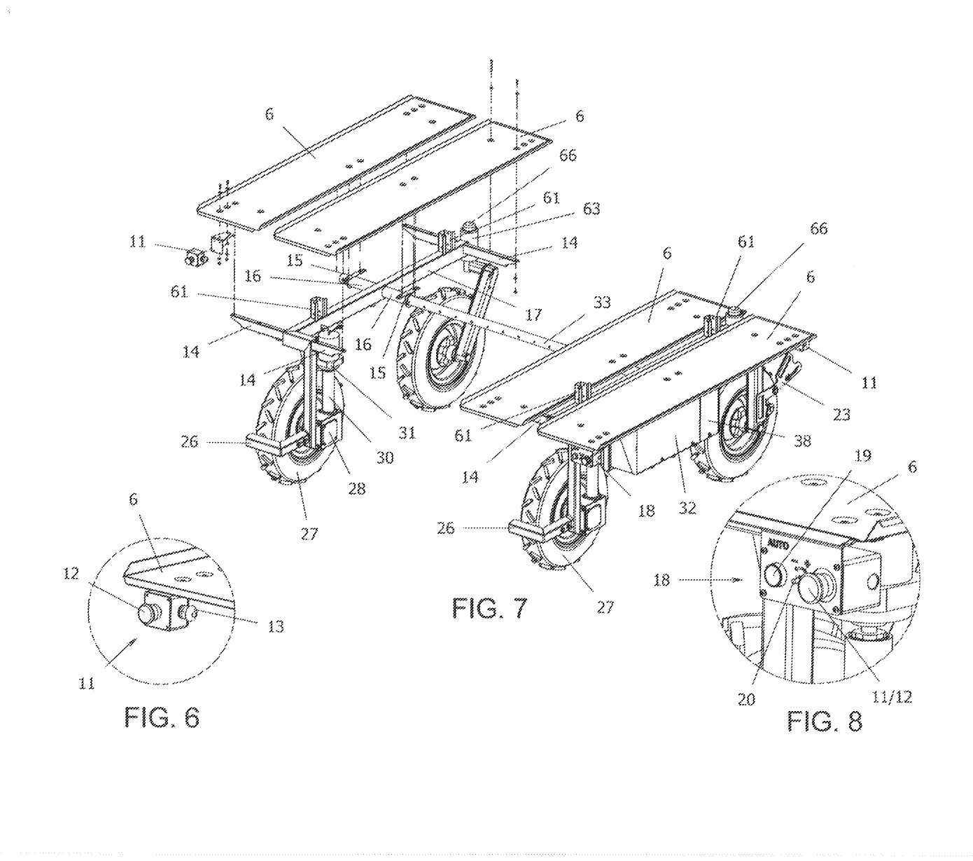

FIG. 6 is a detail perspective view of the emergency stop. In a preferred embodiment, the invention comprises an emergency stop 11 on each of the four corners of the cart. The emergency stop 11 comprises a button 12 that, if pressed, will cut all power to the cart. In FIG. 6, the strain relief 13 to the right of the button 12 is a conduit for the wires that connect the emergency stop 11 to the power source.

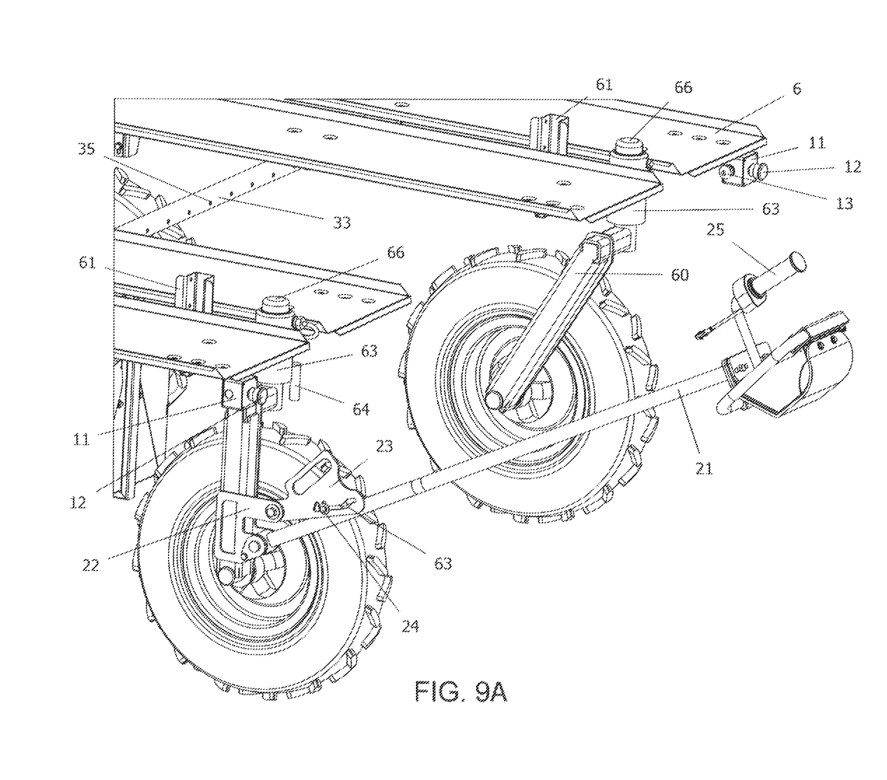

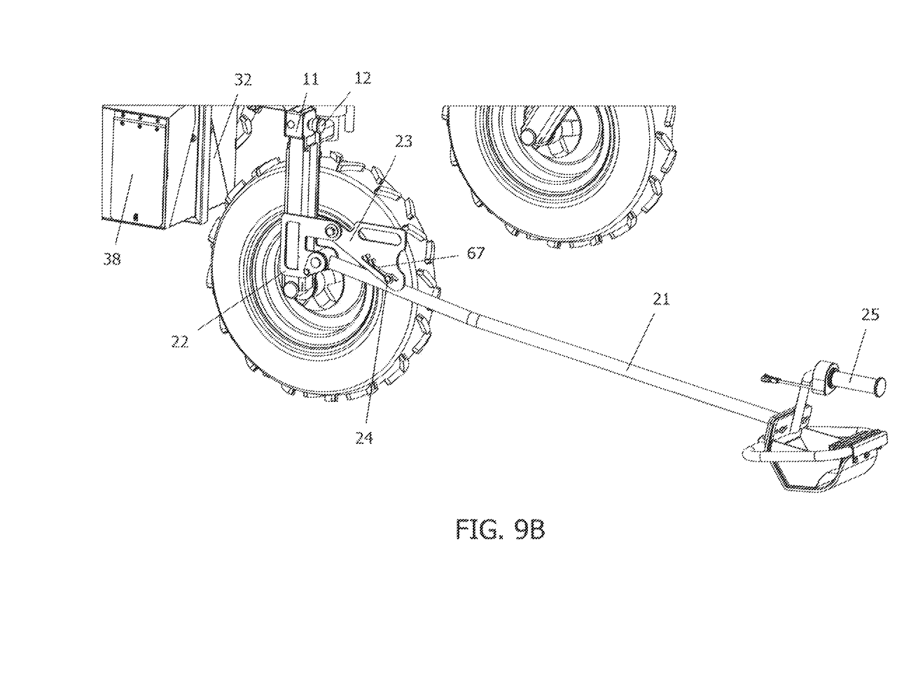

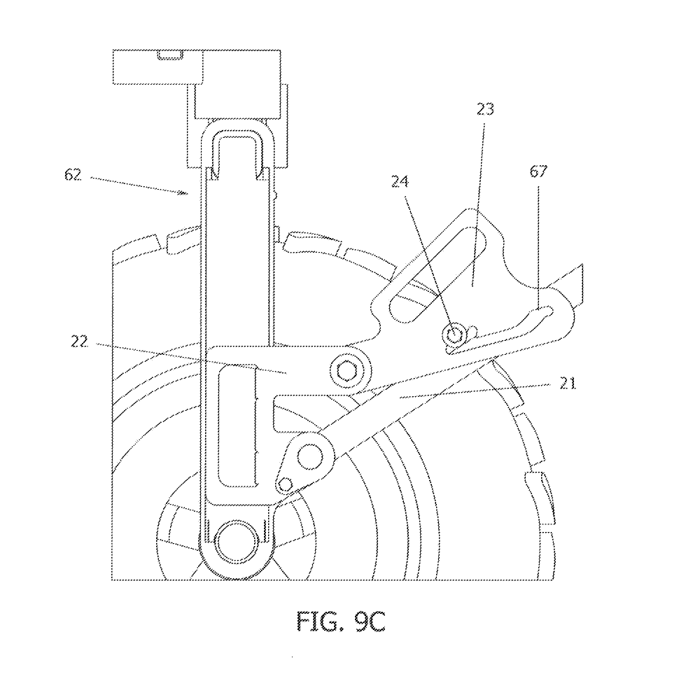

FIG. 7 is a partial exploded view of the caster side of the present invention. This figure shows the steering side of the invention in an assembled state and the caster side of the invention in an exploded view. As shown in this figure, the second set of trays 6 is bolted to a support member 14 situated above each of the wheels and also to brackets 15 that are welded or otherwise secured to tubular extensions 16 that protrude laterally from a connecting member 17 that extends between the two support members 14. The emergency stop 11 on the rear end of the caster side (left-hand side of FIG. 7) is preferably bolted to the underside of the outer corner of the tray 6. Note that three of the emergency stops are visible in this figure; however, there are preferably four emergency stops, one on each corner of the machine (the fourth one is not visible in this figure, but it is visible in FIG. 9).

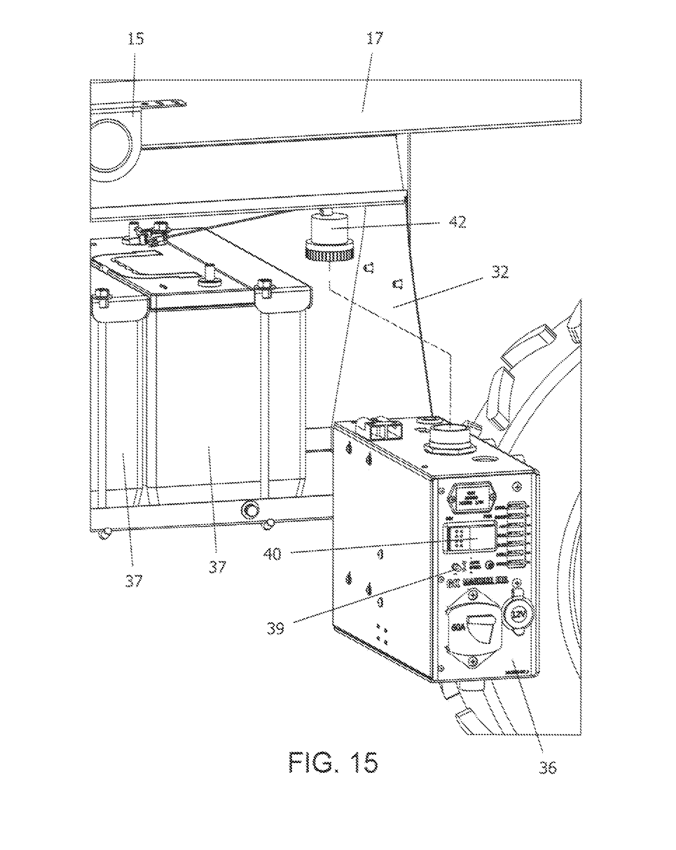

FIG. 8 is a detail perspective view of the rear control box. The rear control box 18 is preferably situated underneath the tray 6 on the rear end of the steering side. The rear control box 18 comprises an emergency stop 11, an auto mode button 19, and a time adjustment knob 20. When pressed, the auto mode button 18 causes the machine to enter “auto” mode from manual mode. When in “auto” mode, the machine will move forward at a pre-determined speed, (this is discussed in connection with FIG. 15) for a given time interval. The time adjustment knob 20 adjusts the time interval (i.e., the amount of time) during which the cart will move forward (or backward) when the auto mode button is pressed. The machine is programmed so that it will automatically revert to manual mode after the designated time interval.

FIG. 9A is a detail perspective view of the guide handle shown in an up position. As shown in this figure, the guide handle 21 is pivotally attached to a bracket 22 that is situated directly above the outer end of the axle of the front wheel on the steering side—this wheel is referred to as the “steering wheel.” A release handle 23 (also referred to as a “tongue lever”) is also pivotally attached to the bracket 22. A bolt 24 extends through a tab (not shown) that is welded onto the guide handle 21 and also through a slot 67 in the release handle 23. When the release handle 23 is pulled upward, the weight of the guide handle 21 causes the bolt 24 to move to the other end of the slot 67, which in turn allows the guide handle 21 to fall to the ground, as shown in FIG. 9B. The guide handle 21 should be in a down position before the auto mode button is pressed; in this manner, the machine will be positioned (steered) to move in a straight direction (without turning right or left) during the period of time in which the machine travels in auto mode. In this position, the guide handle 21 keeps the machine moving straight by lying between two raised beds 1.

As noted above, the machine is programmed to automatically revert to manual mode once the pre-programmed time interval (for auto mode) has elapsed. The guide handle 21 can be left in a down position until the operator hits the auto mode button again. Alternately, to use the machine in manual mode (i.e., manual steering), the operator simply lifts the guide handle 21 until the bolt 24 slides back to the other end of the slot 67, and the guide handle 21 is locked in an up position (as shown in FIG. 9A). Note that the guide handle 21 preferably comprises a twist throttle 25 that allows the power (speed) of the machine to be controlled while it is in manual mode.

The front wheel on the caster side is referred to as a “caster wheel” because it is neither a steering wheel nor a drive wheel (the two rear wheels are both drive wheels). Rather, the caster wheel simply follows the direction and speed dictated by the steering and power wheels, respectively.

FIG. 9C is a detail side view of the release handle. The release handle “locks” in place when the bolt 24 is positioned within one of the two vertical extensions in the release handle slot 67. These two vertical extensions allow for two different height adjustments of the guide handle 21.

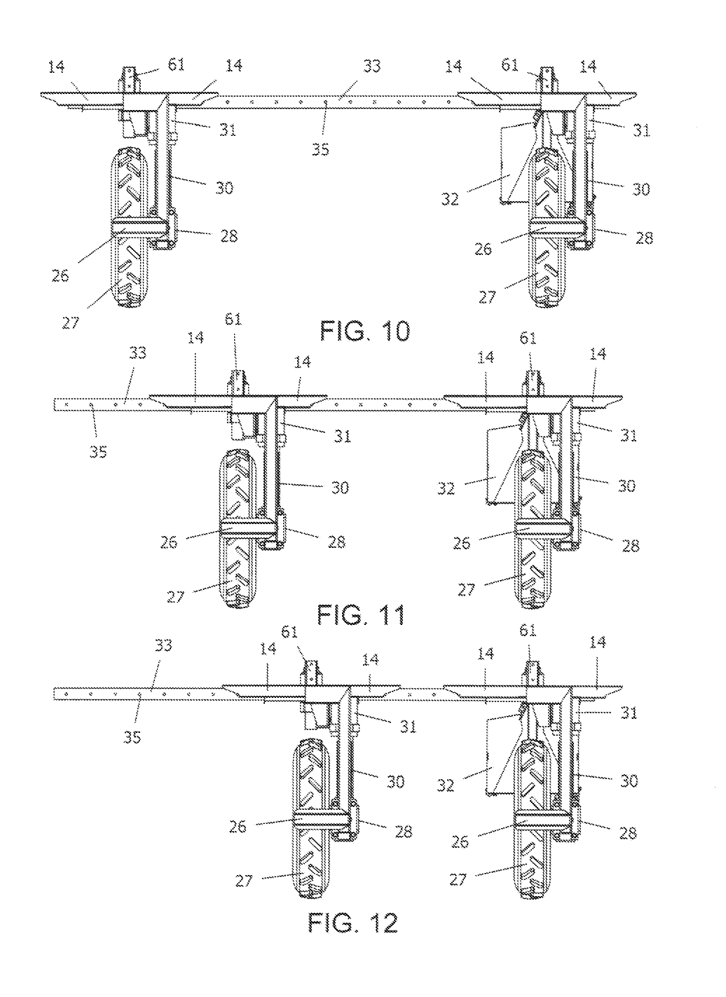

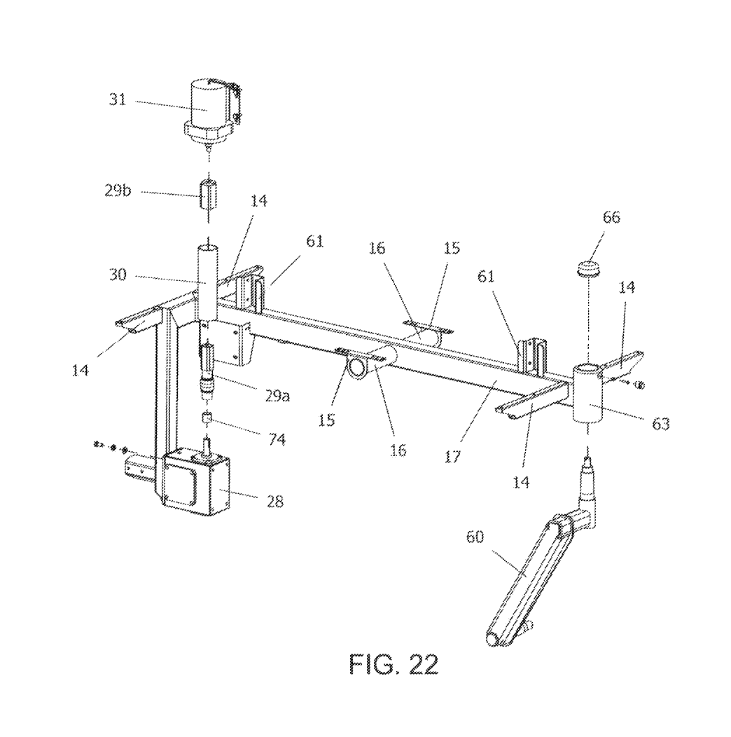

FIGS. 10, 11 and 12 are rear views of the caster side wheel assembly and the steering side wheel assembly shown in a first, second and third relative position, respectively, on the width adjustment tube. Mud scrapers 26 are preferably positioned rearward of each of the two rear wheels 27 (also called the “drive wheels”) for the purpose of scraping mud off of the wheels and to prevent mud from covering the product before it is picked. A gear box 28 is preferably situated on one end of the axle of each of the rear wheels 27. The gear box 28 is connected to a drive (comprised of an inner drive tube 29a and an outer drive tube 29b; see FIG. 22) that is preferably enclosed within a cylindrical cover 30 to protect the operators and also to protect the drive from dust and debris. The drive 29 is connected to a motor 31 (see also FIG. 22). The battery compartment 32 is also shown in FIG. 12.

As illustrated in FIGS. 10-12, the distance between the steering side and the caster side of the machine can be adjusted by moving the position of each wheel assembly on the main cross-bar 33 (also referred to herein as the “width adjustment tube”). This is shown more clearly in FIG. 13.

FIG. 13 is an exploded view of the caster side wheel assembly, the steering side wheel assembly, and the width adjustment tube. The steering side wheel assembly is shown on the right-hand side of this figure, and the caster side wheel assembly is shown in the left-hand side of this figure. The main cross-bar 33 is inserted into the tubular extension 16 on either side of the connecting member 17 on both the steering side wheel assembly and the caster side wheel assembly. The main cross-bar 33 is secured within the tubular extensions 16 with pins 34 that extend through the main cross-bar 33 only (but not through the tubular extensions 16) on the outside of each tubular extension 16. In this manner, the main cross-bar is secured within the tubular extensions 16 but is still allowed to rotate within them. This rotational movement (referred to in the background section above as the “articulated frame”) allows either side of the cart to accommodate undulations (or variations) in the terrain. To move the main cross-bar 33 within the tubular extensions 16 (and thereby increase or decrease the width of the machine), the pins 34 are removed, the main cross-bar 33 is repositioned within the tubular extensions 16, and the pins 34 are reinserted. The main cross-bar 33 comprises a plurality of apertures 35 into which the pins 34 may be inserted.

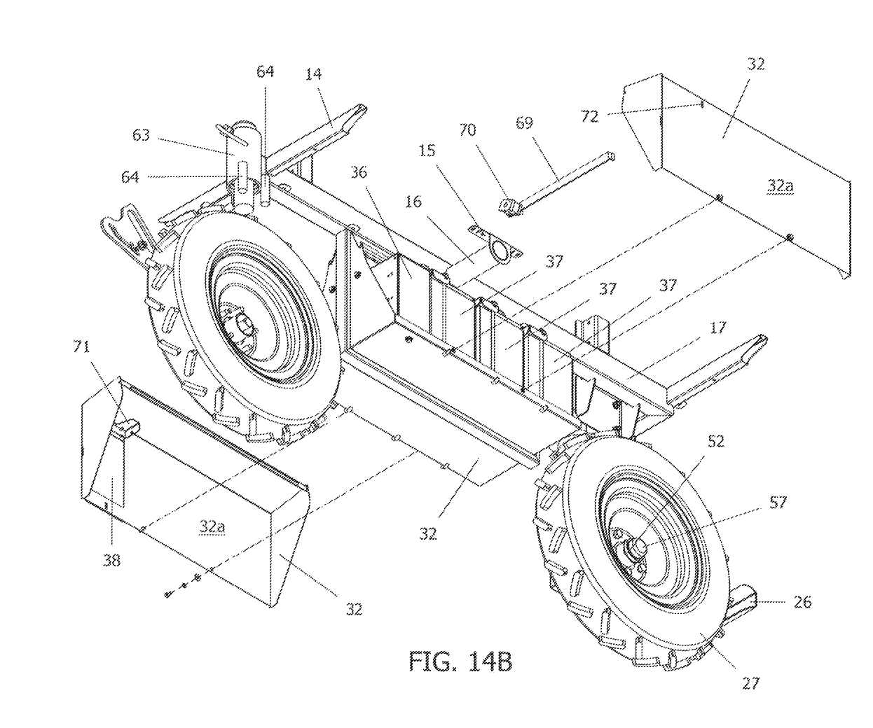

FIG. 14A is an exploded view of the battery compartment of the present invention. The battery compartment 32 preferably houses a main control box 36 and a plurality of batteries 37. The present invention is battery-powered, but the invention is not limited to any particular number or type of batteries. The battery compartment 32 preferably comprises a hinged cover 38 that allows access to the main control box 36. In this embodiment, the battery compartment 32 is situated underneath the connecting member 17 on the steering side of the machine.

FIG. 14B shows the battery compartment from a different perspective. This figure shows the locking bar 69, one end of which extends through a locking bar slot 72 in the first battery compartment cover 32a. The locking bar 69 extends through the battery compartment on top of the batteries 37. A lock 70 is situated on the other end of the locking bar 69, and this lock 70 locks onto a locking bracket 71 on the underside of the second battery compartment cover 32a. The lock 70 is accessible only through the hinged cover 38 on the battery compartment 32.

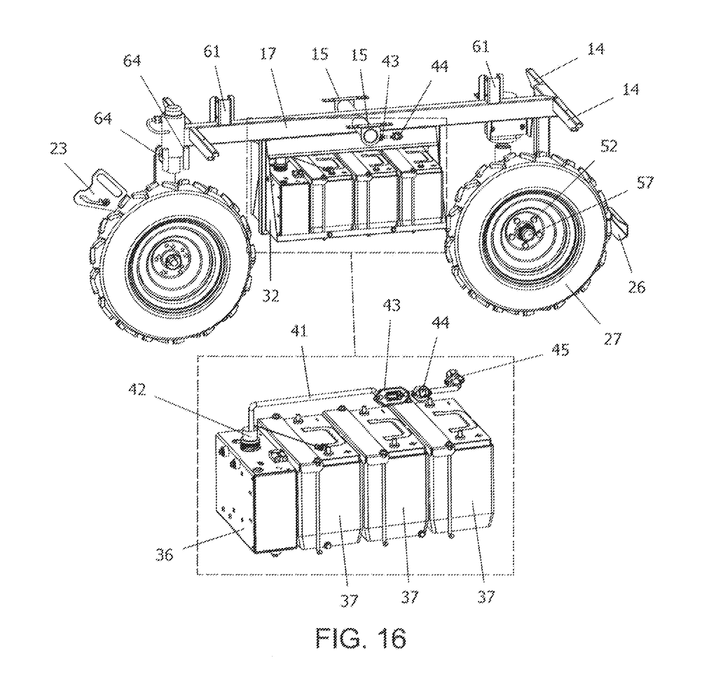

FIG. 15 is a detail perspective view of the main control box. As shown in this figure, the main control box 36 plugs into a first receptacle 42 that is part of the internal harness 41 (see FIG. 16). The main control box 36 houses the motor control system and preferably comprises an auto power knob 39 that controls the power (speed) of the machine in auto mode. The main control box 36 also preferably comprises a forward/reverse switch 40 that allows the operator to put the machine in forward or reverse.

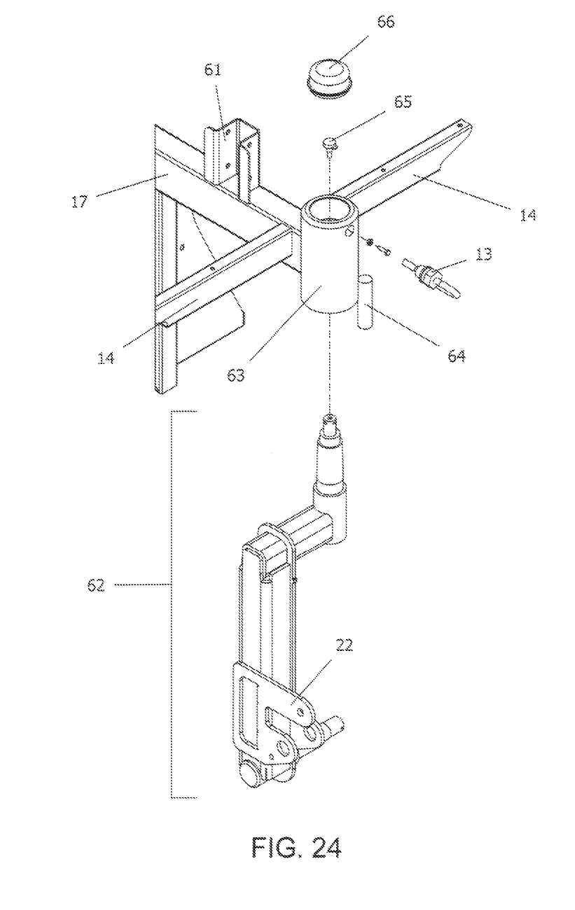

FIG. 16 is a partial exploded view of the main control box and batteries showing the internal harness. The internal harness 41 comprises a first receptacle 42 into which the main control box is plugged. It also comprises a second receptacle 43 for the wiring to the motor and solar panels on the caster side of the machine, a third receptacle 44 for the wiring to all buttons and sensors (the steering sensor is discussed in connection with FIG. 24), and a fourth receptacle 45 for the wiring to the motor and solar panels on the steering side of the machine.

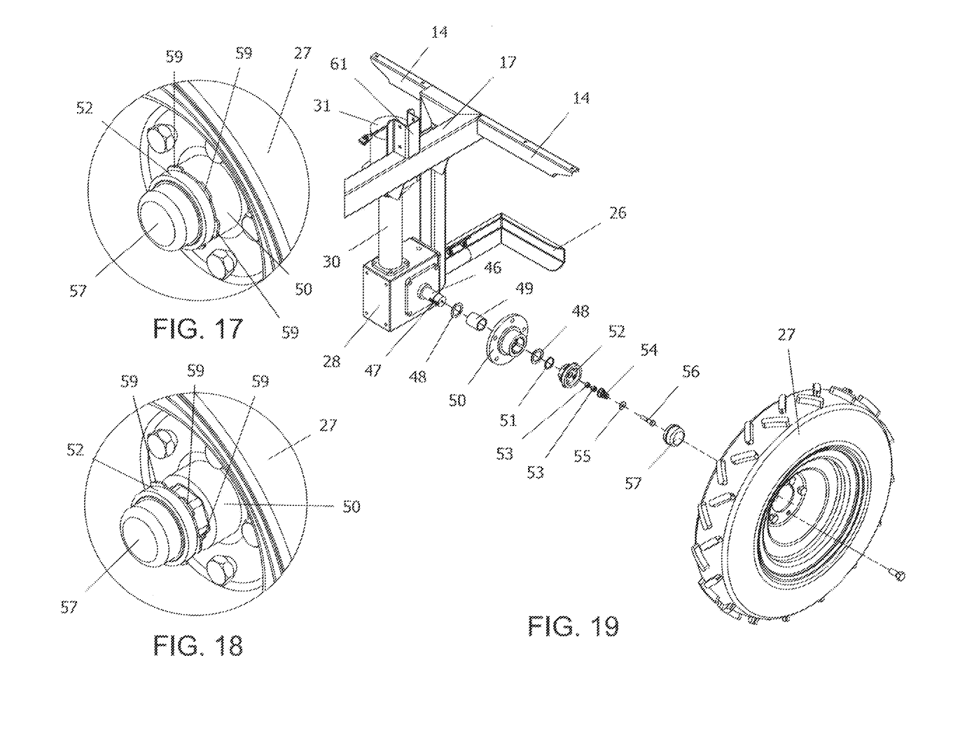

FIG. 17 is a detail perspective view of the locking hub assembly shown with the hubs engaged, and FIG. 18 is a detail perspective view of the locking hub assembly shown with the hubs disengaged. FIG. 19 is an exploded view of the locking hub assembly. As shown in FIG. 19, the gear box 28 comprises a shaft 46 with a keyway 47. The locking hub assembly comprises (working outward from the gear box shaft 46) a washer 48, a bushing 49, a wheel hub 50, a washer 48, a snap ring 51, a drive hub key 52, two nuts 53, a spring 54, a washer 55, a bolt 56 and a hub cap 57.

When fully assembled, the first washer 48 goes onto the shaft 46, the bushing 49 is inserted into the wheel hub 50, and the bushing 49 and wheel hub 50 are positioned around the shaft 46. The next washer 48 is also positioned on the shaft 46 inside of the wheel hub 50. The snap ring 51 holds all of these pieces on the shaft 46. The drive hub key 52 is situated between the shaft 46 and the wheel hub 50. The wheel hub 50 has an inside diameter that is larger than the outside diameter of the shaft 46, and the wheel hub 50 has an internal hex profile that corresponds to the external hex profile of the drive hub key 52 (see FIG. 21). The internal key 58 on the drive hub key 52 fits into the keyway 47 on the gear box shaft 46. The bolt 56 holds the spring 54 against the drive hub key 52. The spring 54 holds the drive hub key 52 in the wheel hub 50. The bolt 56 screws into the (threaded) center of the outward end of the gear box shaft 46. The hub cap 57 is press fit into the drive hub key 52.

The invention is designed so that the two rear/drive wheels can be disengaged from the gear box/drive motor for towing purposes. To disconnect the rear wheel from the gear box, the operator would grab hold of the grip tabs 59 on the drive hub key 52, pull the drive hub key 52 outward and rotate it approximately thirty (30) degrees until the hex portion of the drive hub key 52 is resting on top of the wheel hub 50, as shown in FIG. 18. This action disengages the key 58 on the drive hub key 52 from the keyway 47 on the gear box shaft 46. This action requires the operator to counteract the force of the spring 54. The spring 54 also serves to maintain the drive hub key 52 in the position shown in FIG. 18 until the operator twists the drive hub key 52 and releases it back to the position shown in FIG. 17.

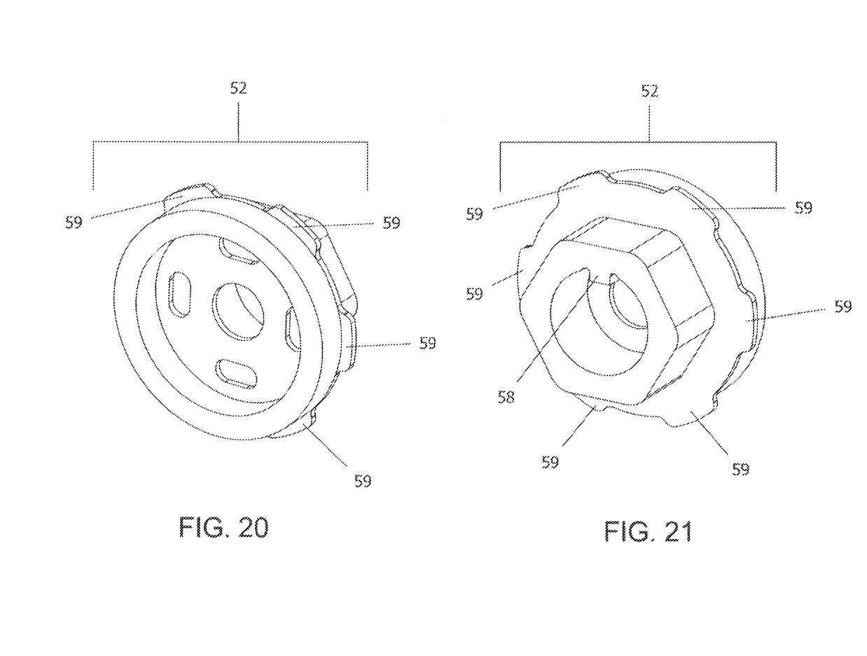

FIG. 20 is a front perspective view of the drive hub key, and FIG. 21 is a rear perspective view of the drive hub key. As shown in these two figures, the drive hub key 52 comprises an internal key 58 that extends inward toward the center of the drive hub key and a plurality of grip tabs 59 situated around the perimeter of the drive hub key. The assembly shown in FIG. 19 applies to both of the rear/drive wheels.

FIG. 22 is an exploded view of the caster side base assembly. The left-hand side of this figure shows the motor and drive assembly, which includes the motor 31, inner drive tube 29a, outer drive tube 29b, cylindrical cover 30 (for the inner and outer drive tubes), spacer 74, and gear box 28 discussed above. FIG. 23 is an exploded perspective view of the motor and drive assembly.

The right-hand side of FIG. 22 shows the front caster wheel (non-steering side) assembly. Note that the front caster wheel assembly preferably comprises a rotatable angle bracket 60 that allows the front caster wheel to swivel/cast freely.

FIG. 22 also shows the two channel brackets 61 that are welded to the top surface of the connecting member 17. The vertical posts 10 described in connection with FIGS. 4A and 4B fit into these channel brackets 61.

FIG. 24 is an exploded view of the front wheel assembly on the steering side. This figure shows the steering fork 62 with bracket 22. As described above in connection with FIG. 9A, both the guide handle 21 and the release handle 23 are attached to the bracket 22. The front wheel assembly further comprises a hub cover 63 with two stops 64 (only one of which is visible in this figure), a steering sensor 65 and a hub cap 66. The steering sensor 65 senses the position of the steering fork assembly and varies power to one or the other of the motors 31 to facilitate a turn.

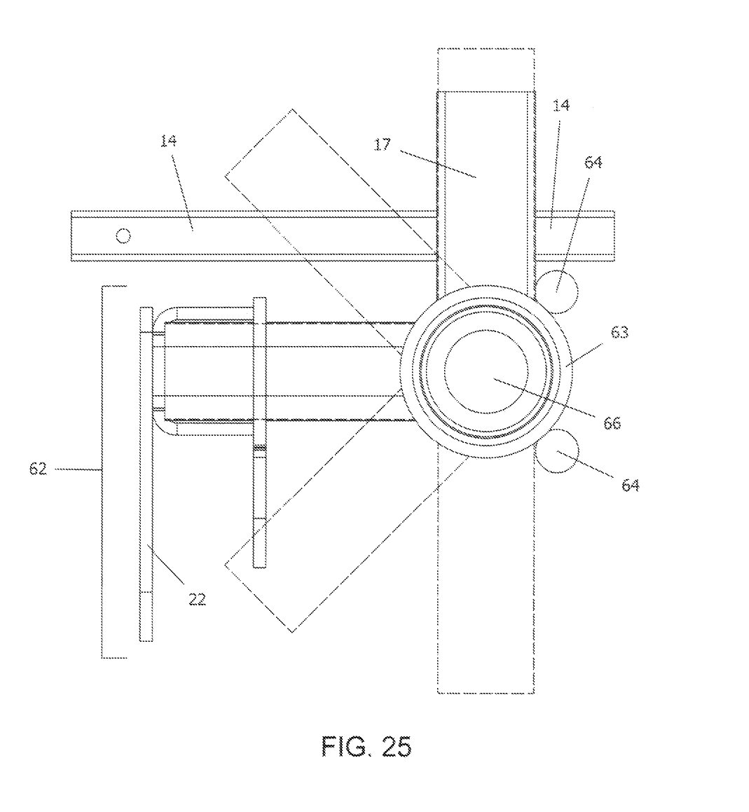

FIG. 25 is a top view of the front wheel assembly on the steering side. This figure shows the steering fork assembly in the position shown in FIG. 24, that is, with the front steering wheel oriented so that the machine will travel straight and not turn. The dotted lines in FIG. 25 illustrate the possible path of rotation of the steering fork. Note that the stops 64 allow the steering fork to rotate ninety (90) degrees in either direction (from the position shown in FIG. 25); in other words, the steering fork may rotate a full one hundred eighty (180) degrees. The purpose of the stops 64 is to prevent over-rotation of the steering fork.

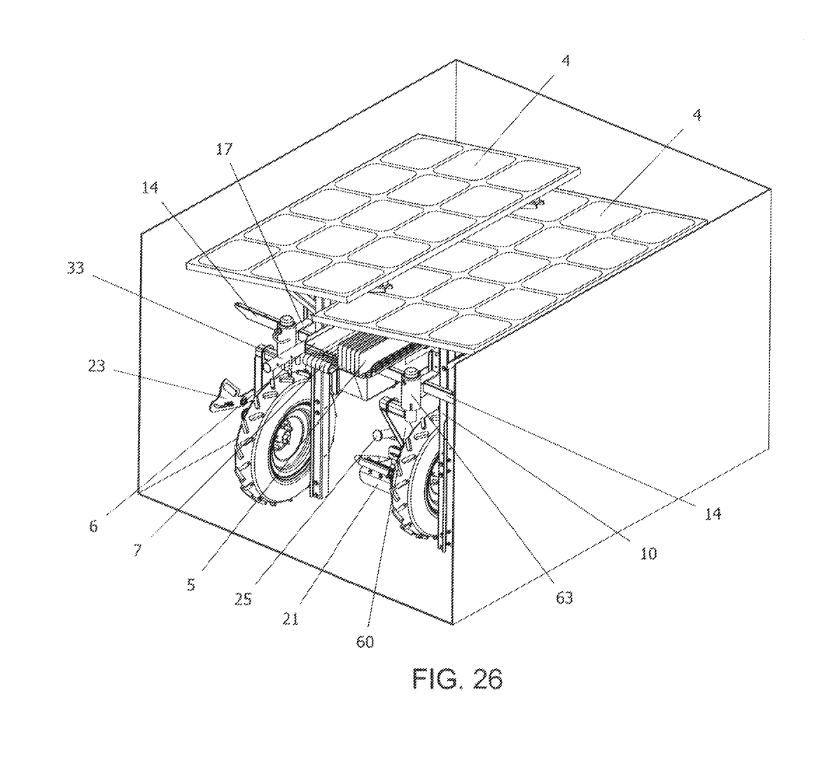

FIG. 26 is a perspective view of the invention in a fully collapsed and partially disassembled state ready for shipment. In this figure, the main cross-bar 33 has been removed from the tubular extensions 16 and the two sides (steering and caster) of the machine placed next to each other. The solar panels 4 have been tiled so that they are relatively horizontal. The first set of trays 5 have been unbolted from the cross-members 9 and stacked together horizontally. The guide handle 21 has been detached (unbolted) from the rest of the machine, and the vertical posts 10 (see FIG. 4) have been decoupled from the channel brackets 61 (see FIG. 22 ) on the connecting members 17. In this configuration, the invention can fit easily into a crate for shipment or storage.

Although the preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

I claim:

1. An electric cart for facilitating the harvesting of berries and other crops comprising:
(a) a steering side wheel assembly comprising a front wheel and a rear wheel connected by a first connecting member, wherein the front wheel is a steering wheel, and the rear wheel is a drive wheel connected to a first battery-powered motor;
(b) a caster side wheel assembly comprising a front wheel and a rear wheel connected by a second connecting member, wherein the front wheel is a caster wheel, and the rear wheel is a drive wheel connected to a second battery-powered motor; and
(c) a main cross-bar connecting the caster side wheel assembly to the steering side wheel assembly so that there is a certain distance between the first and second connecting members, wherein the certain distance between the first and second connecting members is adjustable.

2. The electric cart of claim 1, further comprising a plurality of solar panels that charge at least one battery that supplies power to the first and second battery-powered motors.

3. The electric cart of claim 1, wherein a first pair of tubular extensions extends laterally from the first connecting member, and a second pair of tubular extensions extends laterally from the second connecting member;
wherein the main cross-bar comprises a first end and a second end, and the first end of the main cross-bar is inserted into the first pair of tubular extensions, and the second end of the main cross-bar is inserted into the second pair of tubular extension; and
wherein the main cross-bar rotates within the first and second pairs of tubular extensions to allow the electric cart to accommodate variations in the terrain.

4. The electric cart of claim 1, wherein the electric cart is fully collapsible for transport or storage.

5. The electric cart of claim 1, wherein each of the drive wheels comprises a disengageable drive hub.

6. The electric cart of claim 1, further comprising a first set of racks for storing empty trays and a second set of racks for storing full trays;
wherein the first set of racks is positioned on top of the steering side wheel assembly; and
wherein the second set of racks is positioned directly underneath the first set of racks.

7. The electric cart of claim 1 , further comprising a first set of racks for storing empty trays and a second set of racks for storing full trays;
wherein the first set of racks is positioned on top of the caster side wheel assembly; and
wherein the second set of racks is positioned directly underneath the first set of racks.

8. The electric cart of claim 1 , wherein the electric cart has a manual mode and an auto mode; and
wherein the electric cart travels at a pre-determined speed for a given time interval when the auto mode is activated.

9. The electric cart of claim 8, wherein the given time interval is adjustable by the operator.

10. The electric cart of claim 8, wherein the electric cart automatically reverts to manual mode after the given time interval expires.

11. The electric cart of claim 1, further comprising a guide handle that is pivotally attached to a bracket in proximity to an outer end of an axle of the steering wheel;
wherein the guide handle is configured to be held in a first position when the electric cart is in manual mode and a second position when the electric cart is in auto mode.

12. The electric cart of claim 1, further comprising at least one emergency stop that terminates all power to the electric cart when activated.

13. The electric cart of claim 1, further comprising a forward/reverse switch that controls a direction of travel of the electric cart.

14. The electric cart of claim 1, further comprising a steering sensor;
wherein the steering side wheel assembly further comprises a steering fork assembly; and
wherein the steering sensor senses the position of the steering fork assembly and varies power to the first battery-powered motor to facilitate a turn.

15. The electric cart of claim 1, further comprising a steering sensor;
wherein the steering side wheel assembly further comprises a steering fork assembly; and
wherein the steering sensor senses the position of the steering fork assembly and varies power to the second battery-powered motor to facilitate a turn.

16. The electric cart of claim 1, wherein the steering side wheel assembly further comprises a steering fork assembly:
wherein the steering fork assembly comprises a steering fork; and
wherein the electric cart further comprises one or more stops that prevent over-rotation of the steering fork.
